(19) United States
(12) Patent Application Publication
(10) Pub. No.: US 2013/0268429 A1
(43) Pub. Date: Oct. 10, 2013

(54) Real estate plan methods and systems

(71) Applicant: Kim Marie Henry, Fort Wayne, IN (US)

(72) Inventor: Kim Marie Henry, Fort Wayne, IN (US)

(21) Appl. No.: 13/506,303

(22) Filed: Apr. 10, 2012

(51) Int. Cl. G06Q 50/16; G06Q 40/00

(52) U.S. Cl. 705/39; 705/316

(57) ABSTRACT

Methods and systems for executing a real estate plan for addressing transaction costs relative to a closing of a real estate transaction between a real estate buyer and a real estate seller. The methods and systems facilitate a negotiation between the real estate buyer and the real estate seller of a real estate plan commission fee payable to a real estate plan agent at the closing of the real estate transaction, the real estate commission fee being representative of one or more duties of the real estate plan agent in executing the real estate plan. The methods and systems further generate a real estate plan agreement between the real estate buyer and the real estate seller with the real estate plan agreement specifying the real estate plan commission fee.

The present invention generally relates to a real estate transaction employing agent(s) for a real estate buyer and/or a real estate seller, and involving payment of commission fees to such agent(s) for services rendered during the real estate transaction. The present invention specifically relates to a real estate plan executable by an agent for facilitating negotiations between the real estate buyer and the real estate seller to partially or entirely address transaction costs payable by the real estate buyer and/or the real estate seller prior to and/or at a closing of the real estate transaction.

### BACKGROUND OF THE INVENTION

The following are definition of terms for purposes of understanding the background of the present invention.

The term “real estate” is broadly defined herein as land having a title thereto and any and all attachments to the titled land including, but not limited to, (1) a dwelling (e.g., a house, a condominium or an apartment complex), (2) a commercial building, (3) an industrial facility, (4) natural resources (e.g., water, coil, etc.) and (5) personal property of any kind.

The term “real estate transaction” is broadly defined herein as a partial transfer or a complete transfer to a real estate buyer of legal rights owned, licensed or otherwise obtained by a real estate seller in a specific lot of real estate.

The term “real estate buyer” is broadly defined herein as any entity offering consideration (e.g., currency and/or property) for a purchase of a specific lot of real estate. Examples of a real estate buyer include, but are not limited to, (1) an individual, (2) a group of individuals, (3) a business and (4) a business conglomerate.

The term “buyer agent” is broadly defined herein as any licensed entity contracted by a real estate buyer for transacting a purchase of a specific lot of real estate on behalf of the real estate buyer. Examples of a buyer agent include, but are not limited to, (1) an independent realtor and a (2) real estate agency.

The term “real estate seller” is broadly defined herein as any entity accepting an offer of consideration (e.g., currency and/or property) for a sale of a specific lot of real estate. Examples of a real estate seller include, but are not limited to, (1) an individual, (2) a group of individuals, (3) a business and (4) a business conglomerate.

The term “seller agent” is broadly defined herein as any licensed entity contracted by a real estate seller for transacting a sale of a specific lot of real estate on behalf of the real estate seller. Examples of a seller agent include, but are not limited to, (1) a realtor and (2) a real estate agency. In practice, the buyer agent and the seller agent may or may not be the same entity, or may or may not have a pre-existing business/working relationship.

The term “offer-to-purchase agreement” is broadly defined herein as a legal document signed by a real estate buyer and a real estate seller for a purchase of a specific lot of real estate by the real estate buyer. More particularly, an offer-to-purchase agreement specifies all terms and conditions for a partial transfer or a complete transfer to the real estate buyer of legal rights owned, licensed or otherwise obtained by the real estate seller in the specific lot of real estate.

Examples of terms of an offer-to-purchase agreement include, but are not limited to, (1) identification of the real estate buyer and the real estate seller, (2) identification of the real estate, (3) a negotiated purchase price based on an appraisal of the real estate, (4) a specification of buyer transaction costs and seller transaction costs, and (5) a closing date of the real estate transaction.

Examples of conditions of an offer-to-purchase agreement include, but are not limited to, (1) the real estate buyer acquiring a mortgage loan for the purchase of the real estate, (2) a satisfactory inspection of the real estate revealing no significant defects, (3) a satisfactory repair of one or more items associated with the real estate, (4) a successful sale or purchase of another lot of real estate prior to the closing date of the real estate transaction, and (5) a negotiated purchase price of the real estate being at or below a fair market value determined by an appraisal of the real estate.

The term “buyer transaction costs” is broadly defined herein as any and all costs payable by the real estate buyer prior to and/or at the closing of the real estate transaction. Examples of buyer transaction costs include, but are not limited to, (1) an earnest money payment, (2) a mortgage downpayment of any new mortgage loan, (3) any pro-rata interest on any pre-existing mortgage loan, (4) any applicable lawyer fees, (5) any fees specified by the offer-to-purchase agreement (e.g., title service fees, recording fees, survey fees, appraisal fees, inspection fees and warranty fees), (6) any pre-paid property insurance, (7) any pro-rata property taxes and (8) any pro-rata home association dues.

The term “seller transaction costs” is broadly defined herein any costs payable by the real estate seller prior to and/or at the closing of the real estate transaction. Examples of seller transaction costs include, but are not limited to, (1) any pro-rata interest on a mortgage loan applied by the real estate buyer, (2) any applicable lawyer fees, (3) any fees specified by the offer-to-purchase agreement (e.g., title service fees, recording fees, survey fees, appraisal fees, inspection fees and warranty fees), (4) any pre-paid property insurance, (5) any pro-rata property taxes, and (6) any pro-rata home association dues.

The term “closing administrator” is broadly defined herein as any qualified entity for closing the real estate transaction upon all the condition(s) of the offer-to-purchase agreement being fulfilled by the real estate buyer and/or the real estate seller, particularly the payments of all buyer transaction costs and all seller transaction costs. Examples of a closing administrator include, but are not limited to, a title company.

With the understanding of the definitions of the aforementioned terms, FIG. 1 illustrates a traditional real estate transaction 10 between a buying group 20 consisting of a real estate buyer 21 and an optional buyer agent 22, and a selling group 30 consisting of a real estate seller 31 and an optional seller agent 32. The following description of FIG. 1 is provided in general terms to facilitate a distinction by a real estate transaction 11 shown in FIG. 3 over real estate transaction 10 in view of various basic aspects of any real estate transaction. Thus, those having ordinary skill in the art will appreciate the omission of certain details and any additional participants that are unnecessary for the understanding of the distinction of real estate transaction 11 (FIG. 3) over real estate transaction 10.

FIG. 2 illustrates a flowchart 60 representative of real estate transaction 10. Referring to FIG. 2, a stage S61 of flowchart 60 encompasses a notice of real estate 33 for sale. In practice, the notice of real estate 33 for sale may be accomplished by any customary procedure in the real estate industry. In a first embodiment of stage S61, the notice of real estate 33 for sale is by real estate seller 31 whereby real estate seller 31 with the assistance of a lawyer may market real estate 33 and/or may employ the services of a marketing or online listing company. In a second embodiment of stage S61, real estate seller 31 signs a listing contract with seller agent 32 that specifies details including, but not limited to, terms of the listing and commission(s) to be paid to seller agent 32 and buyer agent 22 and if contracted by real estate buyer 21. Based on the listing agreement, seller agent 32 prepares advertisement information about real estate 33 and conducts various activities to market real estate 33.

Upon response to the notice for sale by real estate buyer 21 and/or buyer agent 22 and if contracted by real estate buyer 21, a stage S62 of flowchart 60 encompasses a negotiation of an offer-to-purchase agreement (“OTPA”) 40 between buying group 20 and selling group 30, and a subsequent execution of a negotiated OTPA 40 by real estate buyer 21 and real estate seller 31. Of particular importance, the executed OTPA 40 specifies most, if not all, buyer transaction costs and seller transaction costs to be paid respectively by real estate buyer 21 and real estate seller 31 prior to and/or at closing of real estate transaction 10.

Upon execution of OTPA 40, a stage S63 of flowchart 60 encompasses a closing of real estate transaction 10 upon all conditions of OTPA 40 being fulfilled by buying group 20 and selling group 30. Of particular importance, closing administrator 51 transacts closing payments to buying group 20 and selling group 30 from a buyer purchase fund (“BPF”) 52 and a transaction closing funds (“TCF”) 53 after the completion of other payments in accordance with OTPA 40. Buyer purchase funds 52 is consideration for the purchase price of real estate 33. Examples of buyer purchase funds 52 include, but are not limited to, a cash account owned by real estate buyer 21 and/or a mortgage loan secured by real estate buyer 21. Transaction closing funds 53 consists of all funds paid by real estate buyer 21 and/or real estate seller 31 to cover all buyer transactions costs and all seller transaction costs prior to and/or at closing of real estate transaction 10.

The closing payments to buying group 20 and selling group 30 include payment of commission fees and compensation to the seller for the sale of real estate 33. For real estate transaction 10 as shown in FIG. 1, from buyer purchase funds 52 and transaction closing funds 53, closing administrator 51 transacts a payment of a buyer agent commission fee (“BAC”) 54 to buyer agent 22 and a payment of a seller agent commission fee (“SAC”) 55 to seller agent 32. After the commission payments, closing administrator 51 transacts a payment of the remaining buyer purchase funds 52 and transaction closing funds 53, if any, to real estate seller 31 as seller transaction compensation (“STC”) 56 for the sale of real estate 33.

In summary, real estate transaction 10 is a representative example of a vibrant housing market. However, the United States (“U.S.”) housing market has experienced a meltdown over the past ten (10) years and is in current need of a private sector solution to a housing market recovery.

Specifically, new home starts in the U.S. have plummeted over the past decade from 1.3 million per year to 300,000, which triggered the mortgage and financial market meltdowns. The crisis in those markets devalued home equity and the assets of U.S. consumers whereby such consumers having good jobs and good credit have no assets left to address the transaction costs of buying a home or to address the transaction costs selling a home. Furthermore, government financial reforms strengthened the financial markets, but created additional financial barriers for consumers. For example, in 2008, a widely used consumer resource entitled “Down Payment Assistance” was eliminated and a 2009 government reform increased the down payment requirements for Federal Housing Authority (“FHA”) loans to 3.5%. As such, fewer resources and increased requirements have exacerbated the U.S. consumer's personal financial crisis to address transactions costs of buying a home or selling a home.

The U.S. Federal Government has acknowledged the consumer's crisis. However, the only current government solutions for U.S. consumers are costly state and federal home ownership programs. These grants, gifts and mortgage programs are funded with tax payer revenue and target a narrow group including first time real estate buyers and the low to moderately-low households. Moreover, in June 2011, the Congressional Budget Office (“CBO”) reported the U.S. Federal Government will spend $42 billion to continue mortgage activity in the next decade in addition to the $260 billion spent on homeownership programs. Unequivocally, long term widespread housing stability cannot be achieved through costly government spending that regularly exceeds budget.

### BRIEF SUMMARY OF THE INVENTION

In 2007, U.S. Congressional findings in Housing America's Workforce Act called for “innovative local solutions” and for employers to “provide much needed housing assistance to their employees”. While Harvard University's Housing Studies reported in 2000 that housing plans have been used by the U.S. employers since the 1800s, the only current use of such housing plans by U.S. employers is executive relocation plans and the only current us of such housing plans by government is with federal employees and the military to subsidize all costs associated with the relocation.

A provision of a housing plan for every employee is too expensive and impractical for employers and the federal government. Thus, in response to the call for “innovative local solutions” and for employers to “provide much needed housing assistance to their employees”, the present invention provides a new and unique real estate plan to partially or entirely address transaction costs payable by the real estate buyer and/or the real estate seller prior to and/or at a closing of the real estate transaction. The new and unique real estate plan (1) eliminates the need for government funded gifts, grants and entitlement programs, (2) supports tax revenue, provides jobs and increases commerce in the real estate industry and (3) affordable and practical for employers and the federal government.

The term “buyer real estate plan” is broadly defined herein as an exercisable compensation payment by a real estate plan provider in the form of income or a benefit to a real estate buyer for purposes of addressing transaction costs prior to and/or at a closing of a real estate transaction. Examples of a real estate plan provider for the real estate buyer include, but are not limited to, (1) a part-time or a full-time employer of the real estate buyer as an employee or independent contractor, (2) an association of which the real estate buyer is a member (e.g., a union), (3) a third-party benefit administrator for an employer or an association of the real estate buyer, and (4) a relocation service company.

The term “seller real estate plan” is broadly defined herein as an exercisable compensation payment by a real estate plan provider in the form of income or a benefit to a real estate seller for purposes of addressing transaction costs prior to and/or at a closing of a real estate transaction. Examples of a real estate plan provider for the real estate seller include, but are not limited to, (1) a part-time or a full-time employer of the real estate seller as an employee or independent contractor, (2) an association of which the real estate seller is a member (e.g., a union), (3) a third-party benefit administrator for an employer or an association of the real estate seller, and (4) a relocation service company.

The term “real estate plan agent” is broadly defined herein as any licensed entity for facilitating negotiations of a real estate plan agreement between a real estate buyer and a real estate seller. Examples of a real estate plan agent include, but are not limited to, (1) an escrow attorney, (2) an independent realtor and (3) a real estate agency. In practice, the real estate plan agent may or may not be associated within the real estate plan provider (e.g., an employee of a real estate plan provider).

The term “real estate plan agreement” is broadly defined herein as a legal document signed by the real estate buyer and the real estate seller for an exercise of a buyer real estate plan by the real estate buyer and/or an exercise of a seller real estate plan by the real estate seller. More particularly, the real estate plan agreement specifies all terms and conditions for the exercise of real estate plan(s) by the real estate buyer and/or the real estate seller. Of importance, the real estate agreement includes a standard term specifying a real estate plan commission fee payable to the real estate plan agent at closing of the real estate transaction. Examples of additional terms of a real estate plan agreement include, but are not limited to, (1) identification of the real estate buyer, the real estate seller and the real estate plan agent, and (2) administrative duties of the real estate plan agent in exercising the real estate plan(s) on behalf of the real estate buyer and/or the real estate seller.

In practice, the real estate plan commission fee may be derived from various factors related to the real estate transaction and/or the real estate plan. Examples of such factors include, but are not limited to, (1) a provisional purchase price of the real estate or a negotiated purchase price of the real estate, and (2) the quantity and complexity of administrative duties of the real estate agent in exercising the real estate plan. The term “provisional purchase price” is broadly defined herein as (1) a listing purchase price of the real estate, (2) an appraised purchase price of the real estate, and (3) a proposed purchase price of the real estate by the real estate buyer and/or the real estate.

Also in practice, the administrative duties of the real estate in exercising the real estate plan range from a single task of a notification to the real estate plan provider of an executed real estate plan agreement to additional tasks including a notification to the closing administrator of the executed real estate plan agreement and a management of an escrow account of a real estate plan compensation to the closing of the real estate transaction. If derived from the provisional purchase price or negotiated purchase price, then the real estate plan commission fee will be negotiated as a percentage of the provisional purchase price or negotiated purchase price partially or entirely based on the quantity and complexity of the administrative duties of the real estate plan agent.

One form of the present invention is a server-based method for executing a buyer real estate plan for addressing buyer transaction costs relative to a closing of a real estate transaction between a real estate buyer and a real estate seller. The method involves an operation of a real estate server to facilitate a negotiation between the real estate buyer and the real estate seller of a real estate plan commission fee payable to a real estate plan agent at the closing of the real estate transaction, wherein the real estate commission fee is representative of one or more one duties of the real estate plan agent in executing the buyer real estate plan. The method further involves an operation of the real estate server to generate a real estate plan agreement between the real estate buyer and the real estate seller, wherein the real estate plan agreement specifies the real estate plan commission fee.

Another form of the present invention is a server-based system for executing a buyer real estate plan for addressing buyer transaction costs relative to a closing of a real estate transaction between a real estate buyer and a real estate seller. The server-based system employs a processor and real estate plan application including a first set of instructions executable by the processor to facilitate a negotiation between the real estate buyer and the real estate seller of a real estate plan commission fee payable to a real estate plan agent at the closing of the real estate transaction, wherein the real estate commission fee is representative of one or more duties of the real estate plan agent in executing the buyer real estate plan. The real estate plan application further includes a second set of instructions executable by the processor to generate a real estate plan agreement between the real estate buyer and the real estate seller, wherein the real estate plan agreement specifies the real estate plan commission fee.

The foregoing forms and other forms of the present invention as well as various features and advantages of the present invention will become further apparent from the following detailed description of various embodiments of the present invention read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates an exemplary real estate transaction as known in the art.

FIG. 2 illustrates a flowchart representative of the exemplary real estate transaction shown in FIG. 1.

FIG. 3 illustrates a first exemplary real estate transaction in accordance with the present invention.

FIG. 4 illustrates a flowchart representative of the exemplary real estate transaction shown in FIG. 3.

FIG. 5 illustrates an exemplary embodiment of a real estate plan server in accordance with the present invention.

FIG. 6 illustrates a flowchart representative of a real estate plan method in accordance with the present invention.

FIG. 7 illustrates a second exemplary real estate transaction in accordance with the present invention.

### DETAILED DESCRIPTION OF THE INVENTION

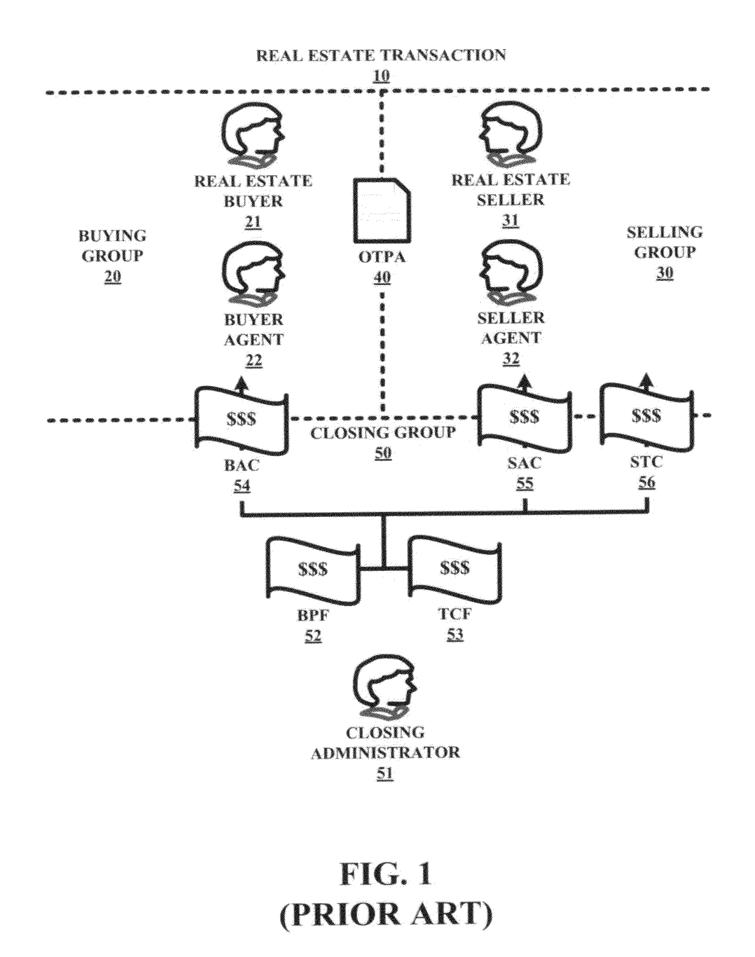

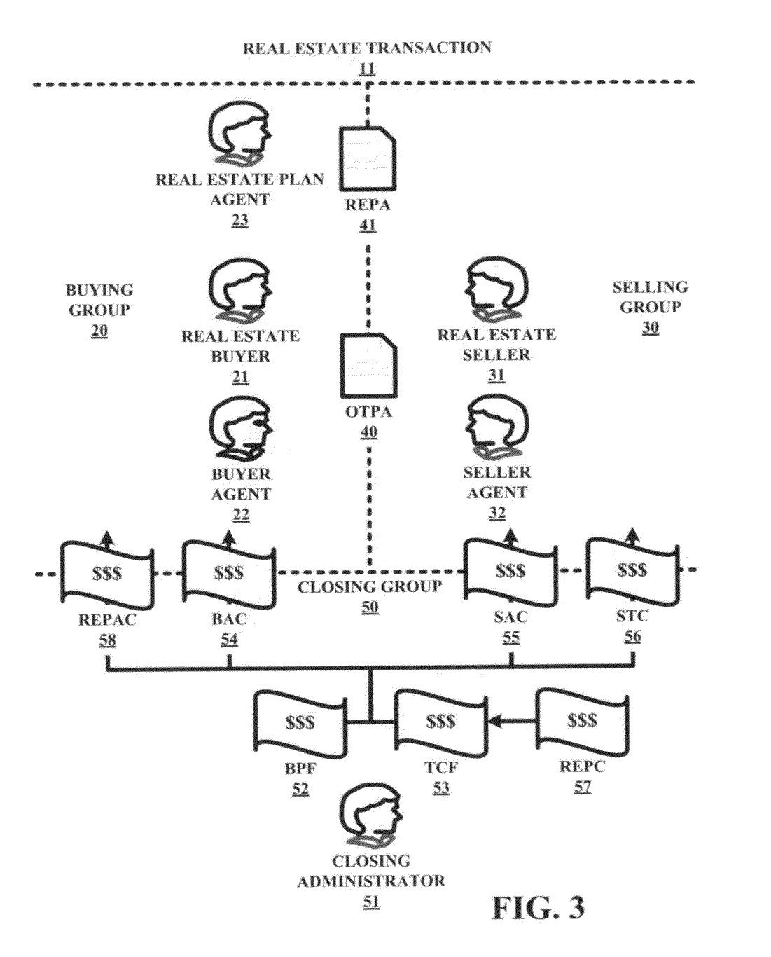

FIG. 3 illustrates a new and unique real estate transaction 11 between buying group 20 and selling group 30 of FIG. 1 with buying group 20 additionally including a real estate plan agent 23 for facilitating negotiations of a real estate plan agreement between real estate buyer 21 and real estate seller 31 for the exercise of a buyer real estate plan of the present invention by real estate buyer 21. Specifically, the exercise of the buyer real estate plan involves a compensation payment by a real estate plan provider in the form of income or a benefit to real estate buyer 21 for purposes of addressing transaction costs prior to and/or at a closing of real estate transaction 11.

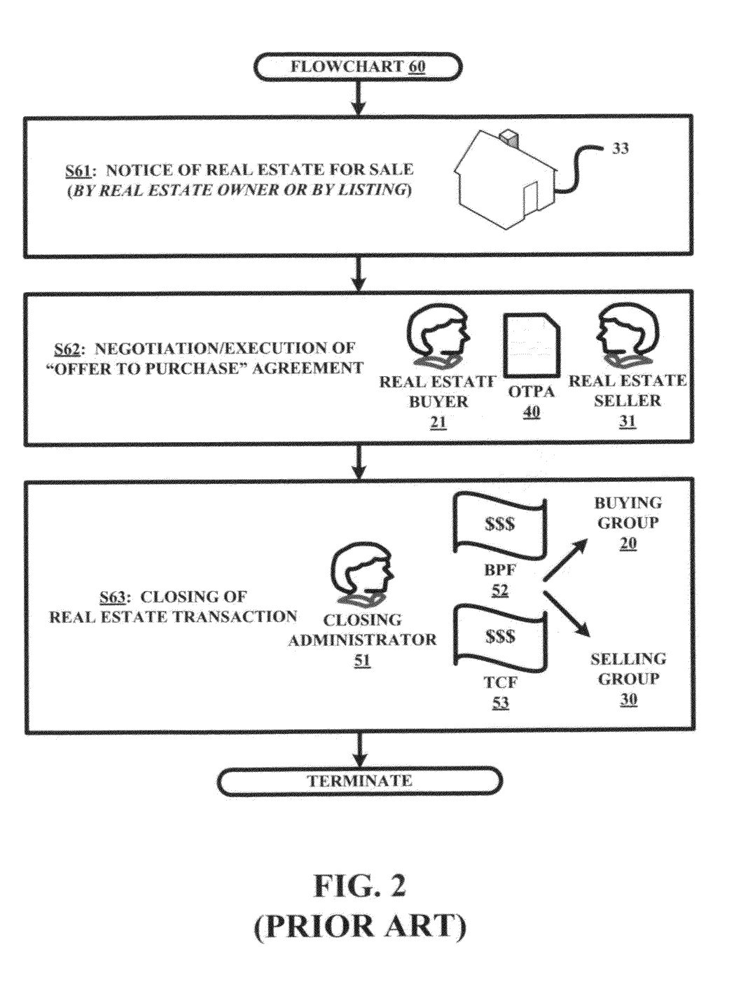

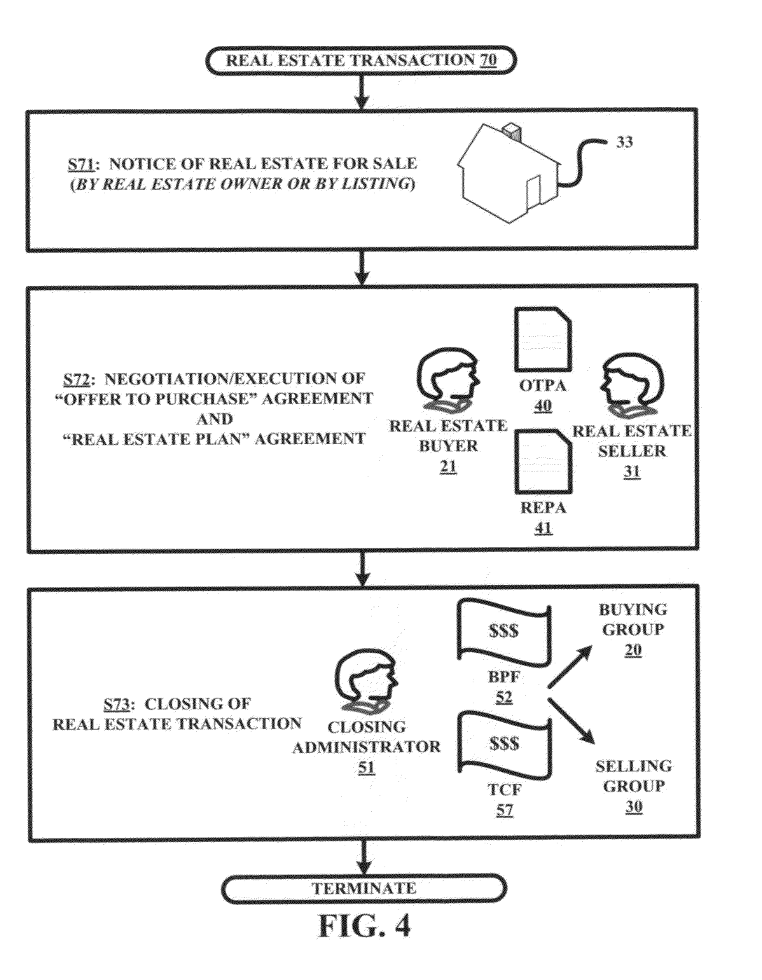

FIG. 4 illustrates a flowchart 70 representative of real estate transaction 11. Referring to FIG. 4, a stage S71 of flowchart 70 encompasses a notice of real estate 33 for sale as previously described herein in connection with the description of state S61 of FIG. 2.

Upon response to the notice for sale by real estate buyer 21 and/or buyer agent 22 if contracted by real estate buyer 21, a stage S72 of flowchart 70 encompasses a negotiation and execution of an offer-to-purchase agreement (“OTPA”) 40 between buying group 20 and selling group 30 as previously described herein in connection with the description of stage S62 of FIG. 2. Concurrently and/or sequentially, stage S72 of flowchart 70 encompasses a negotiation and execution of a real estate plan agreement (“REPA”) 41 between real estate buyer 21 and real estate seller 31 as facilitated by real estate plan agent 23. Restate plan agreement 41 specifies all terms for the exercise of the buyer real estate plan by real estate buyer 21. Of importance, OTPA 40 specifies a provisional purchase price or a negotiated purchase price of real estate 33 and REPA 51 includes a standard term specifying a real estate plan commission fee as a percentage of the negotiated purchase price and payable to the real estate plan agent at a closing of the real estate transaction.

In practice, negotiable terms and conditions of the OTPA 40 and REPA 41 may be concurrently and/or sequentially negotiated between real estate buyer 21 and real estate seller 31. For example, discussions of a provisional purchase price of real estate 33 between real estate buyer 21 and real estate seller 31 may occur concurrently or prior to a negotiation of the real estate plan commission fee between real estate buyer 21 and real estate seller 31. Alternatively, a negotiation of the real estate plan commission fee between real estate buyer 21 and real estate seller 31 may occur concurrently or subsequent to the negotiated purchase price of real estate 33 between real estate buyer 21 and real estate seller 31.

Upon execution of both OTPA 40 and REPA 41, a stage S63 of flowchart 60 encompasses a closing of real estate transaction 11 upon all conditions of OTPA 40 and REPA 41 being fulfilled by buying group 20 and selling group 30. Of particular importance, closing administrator 51 transacts closing payments to buying group 20 and selling group 30 from buyer purchase fund (“BPF”) 52 and transaction closing funds (“TCF”) 53 after the completion of other payments in accordance with OTPA 40. As previously described herein in connection with the description of FIG. 1, buyer purchase funds 52 is consideration for the purchase price of real estate 33. For the real estate plan of the present invention, prior to the closing of real estate transaction 10, real estate plan agent 23 manages an escrow account including real estate plan compensation 57 provided by the real estate plan provider in accordance with the REPA 41. For the closing of real estate transaction 10, real estate plan agent 23 manages a transfer of real estate plan compensation 57 to closing administrator 51 from the escrow account whereby transaction closing funds 53 consists of real estate plan compensation 57 as well as all funds paid by real estate buyer 21 and real estate seller 31 to cover buyer transactions costs and seller transaction costs prior to and/or at the closing of real estate transaction 10.

The closing payments to buying group 20 and selling group 30 include payment of commission fees and compensation to the seller for the sale of real estate 33. For real estate transaction 11 as shown in FIG. 3, from buyer purchase funds 52 and transaction closing funds 53, closing administrator 51 transacts a payment of buyer agent commission fee (“BAC”) 54 to buyer agent 22, a payment of seller agent commission fee (“SAC”) 55 to seller agent 32 and a payment of real estate agent commission fee (“REPAC”) 58 to real estate plan agent 23. After the commission payments, closing administrator 51 transacts a payment of the remaining buyer purchase funds 52 and transaction closing funds 53 to real estate seller 31 as seller transaction compensation (“STC”) 56 for the sale of real estate 33.

In summary, real estate transaction 11 is a representative example of a private solution to a real estate recovery, particularly in the housing market. Generally, the addition of real estate plan compensation 57 to transaction closing funds 53 provides means for real estate buyer 21 to participate in real estate transaction 70 despite a lack of sufficient assets otherwise to participate in real estate transaction 11 at market value for real estate 33.

Specifically, the following Table illustrates differences between real estate transaction 10 and real estate transaction 11 in view of real estate buyer 21 lacking sufficient funds to address buyer transaction costs and further illustrates the inventive advantages of the buyer real estate plan.

| | Transaction 10 | Transaction 11 | Inventive |
|---|---|---|---|
| Category | (FIG. 1) | (FIG. 3) | Advantage |
| Real Estate | $150,000.00 | $150,000.00 | — |
| Appraisal | | | |
| Value: | | | |
| Buyer | $5,250.00 | $5,250.00 | — |
| Transaction | | | |
| Costs (BTC): | | | |
| Real | N/A | $5,000.00 | Taxable |
| Estate Plan | | | Income for |
| Compensation: | | | Buyer 21 |
| Real | N/A | $6,750.00 | Taxable |
| Estate Plan | | (4.5% Commission) | Income for |
| Agent Fees | | | Agent 23 |
| (REF): | | | |
| Negotiated | $125,000.00 | $150,000.00 | Higher |
| Purchase | | | Property |
| Price (NPP): | | | Tax Basis |
| Relator | $7,500.00 | $9,000.00 | Higher |
| Agent | (6% Commission) | (6% Commission) | Commissions |
| Fees (AF): | | | for Agents |
| | | | 22/32 |
| Seller | $1,500.00 | $1,500.00 | — |
| Transaction | | | |
| Costs (STC): | | | |
| Net to | $114,000.00* | $132,750.00 | Higher Net |
| Seller: | (NPP − | (NPP − | for Seller |
| | AF − STC) | AF − STC − REF) | |

Referring to the above Table, in view of real estate buyer 21 lacking sufficient funds to cover the buyer transaction cost in real estate transaction 10, the negotiated purchase price of real estate 33 is reduced by $25,000 from the appraised market value of $150,000 to $125,000 to thereby reduce the buyer transaction costs to a level supportable by real estate buyer 21. By comparison, with real estate buyer 21 receiving real estate plan compensation of $5,250 to address the buyer transaction costs for real estate transaction 11, the negotiated purchase price of real estate 33 equals the appraised market value of real estate 33 to maintain the appraised value of real estate 33 for market and property tax purposes. Furthermore, (1) additional taxable income is generated for real estate buyer 21, buyer agent 22, real estate plan agent 23 and seller agent 32, and (2) real estate seller 31 receives a higher net compensation for the sale of real estate 33.

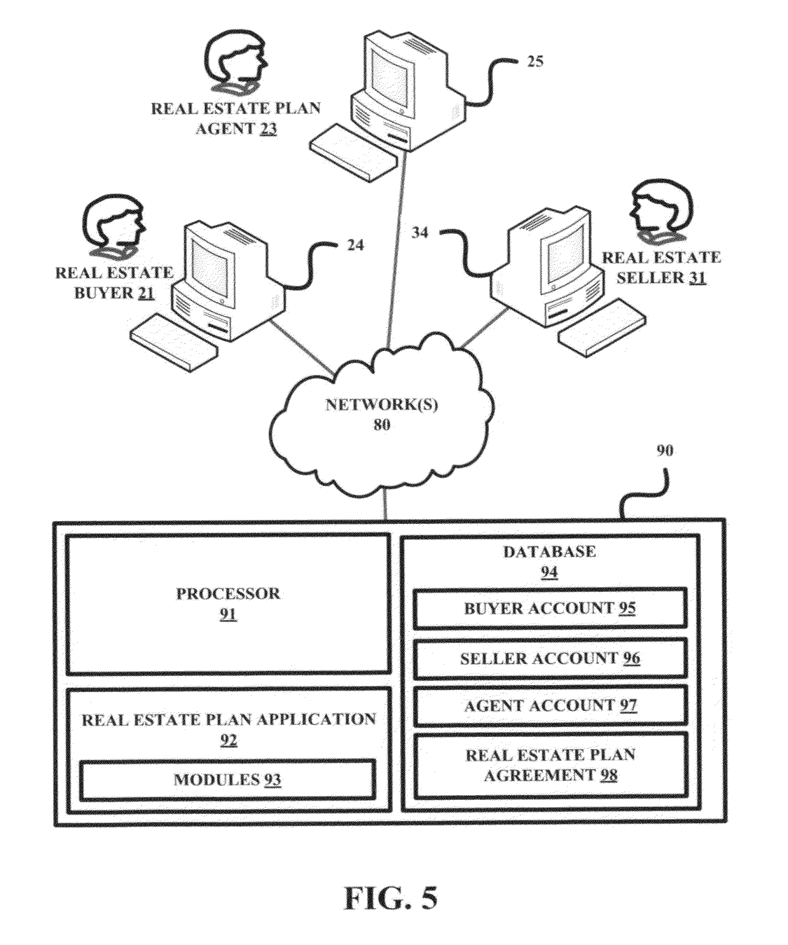

In practice, real estate plan agent 23 utilizes a server-based system to host the negotiations and execution of a real estate plan agreement between real estate buyer 21 and real estate seller 31. In one embodiment, as shown in FIG. 5, an agent client terminal 25, a buyer client terminal 24 and a seller client terminal 34 are connected via a network 80 (e.g., the Internet, a local area network or a wide area network) to a real estate plan server 90 whereby real estate plan agent 23 may host the negotiations and execution of the real estate plan agreement between real estate buyer 21 and real estate seller 31 for exercising a buyer real estate plan.

In practice, real estate plan server 90 may be any commercially available application server including, but not limited to, application servers offered by International Business Machine, Sun Microsystems, Hewlett-Packard and Apple. Accordingly, those having ordinary skill in the art will appreciate the various components customarily associated with an application server. Nonetheless, only a processor 91, a real estate plan application 92 and a database 94 are shown in FIG. 5 as the only components of real estate server 90 necessary by those having ordinary skill in the art for an understanding of an operation of real estate server 90 in supporting a hosting by real estate agent 23 of the negotiations and execution of a real estate plan agreement between real estate buyer 21 and real estate seller 31 for exercising a buyer real estate plan.

For purposes of the present invention, processor 92 is broadly defined herein as any device for executing program instructions of real estate application 92 to thereby implement a real estate plan method of the present invention defined by those instructions. Examples of processor 92 include, but are not limited to, one or more microprocessors, one or more central processing units, one or more microcontrollers and one or more digital signal processors.

For purposes of the present invention, real estate plan application 93 is broadly defined herein as a physical storage of a computer program on one or more computer readable mediums (not shown) including, but not limited to, on-volatile media of any type, volatile media of any type, and transmission media of any type, whereby the computer program includes instructions executable by processor 92 for implementing a real estate plan method of the present invention defined by those instructions. Thus, by definition, real estate plan application 93 includes computer readable medium(s) stored thereon.

For purposes of the present invention, database 94 is broadly defined herein as any system designed to organize, store and facilitate quick retrieval of data generated by a real estate plan method of the present invention. Examples of database 94 include, but are not limited to, any type of relational database management system.

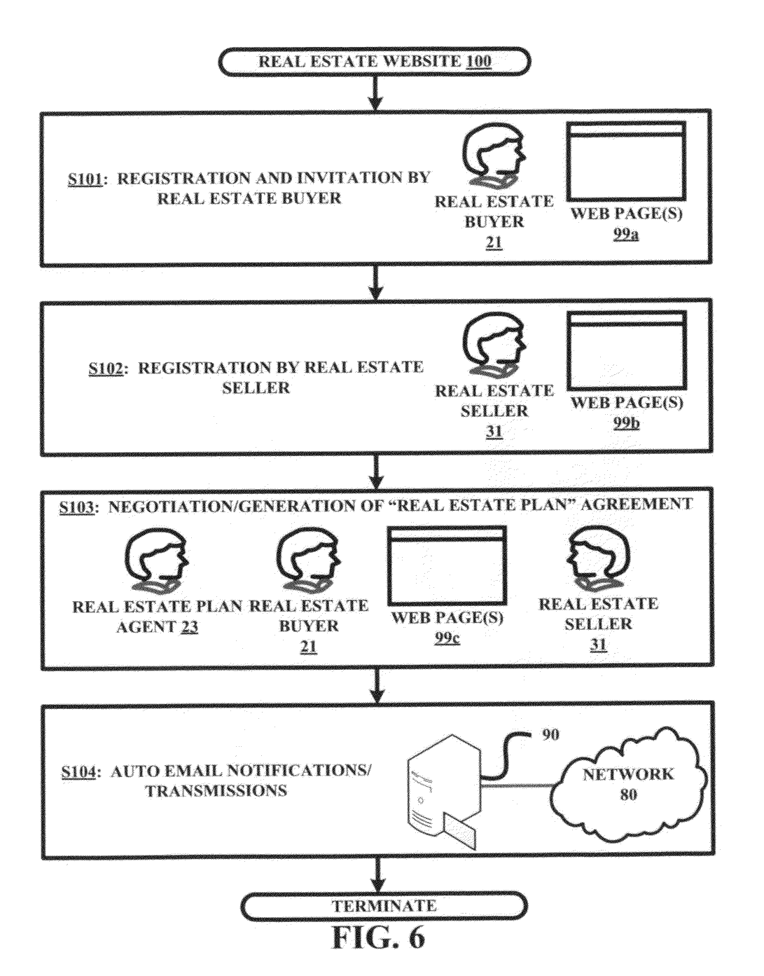

In one embodiment of real estate server 90, real estate plan application 92 includes modules 93 having instructions executable by processor 92 for providing a real estate website to real estate buyer 21 and real estate seller 31 in accordance with a flowchart 100 as shown in FIG. 6.

Referring to FIG. 6, after one or more introductory/instructional webpages, a stage S101 of flowchart 100 encompasses a presentation of one or more interactive webpages 99a on buyer client terminal 24 whereby real estate buyer 21 may register on server 90 for purposes of exercising a buyer real estate plan. In practice, the buyer registration involves a creation of a buyer account 95 (FIG. 5) in database containing relevant information associated with real estate buyer 21 and real estate transaction 11 (e.g., buyer name and contact information, identification of real estate, provisional purchase price or negotiated purchase price, etc.). Additionally, the buyer registration may involve a pre-listing of various terms and conditions of the real-estate plan agreement that may be accepted by or modified by real estate buyer 21. Examples of such terms and conditions include, but are not limited to, duties of real estate agent 23 and a percentage of a provisional purchase price or negotiated purchase price of real estate 33 as the real estate plan commission fee.

Those having ordinary skill in the art will appreciate how to program a buyer registration module suitable to obtain required information associated with real estate buyer 21 and real estate transaction 11 for purposes of buyer registration.

Stage S101 of flowchart 100 further encompasses emailing an invitation to real estate seller 31 via an email address provided by real estate buyer 21. Upon acceptance of the invitation, a stage S102 of flowchart 100 encompasses a presentation of one or more interactive webpages 99b on seller client terminal 34 whereby real estate seller 31 may register on server 90 for purposes of negotiating the real estate plan agreement. In practice, the seller registration involves a creation of a seller account 96 (FIG. 5) containing relevant information associated with real estate seller 31 (e.g., seller name and contact information) as well as relevant information associated with real estate transaction 11 not provided by and/or applicable to real estate buyer 21. Additionally, the seller registration may involve a pre-listing of various terms and conditions of a real estate plan agreement that may be accepted by or modified by real estate seller 21. Again, examples of such terms and conditions include, but are not limited to, duties of real estate agent 23 and a percentage of a provisional purchase price or negotiated purchase price of real estate 33 as the real estate plan commission fee.

Those having ordinary skill in the art will appreciate how to program a seller registration module suitable to obtain required information associated with real estate seller 31 and real estate transaction 11 for purposes of seller registration.

Upon the registration of real estate seller 31, a stage S103 of flowchart 100 encompasses a negotiation and/or generation of the real estate plan agreement. In one embodiment of stage S103, a concurrent presentation or a nonsimultaneous presentation of one or more interactive webpages 99c on buyer client terminal 24 and seller client terminal 34 enables real estate buyer 21 and real estate seller 31 to negotiate terms and conditions of the real estate plan agreement. In an alternate embodiment of stage S103, a concurrent presentation or a nonsimultaneous presentation of webpage(s) 99c on buyer client terminal 24 and seller client terminal 34 provides a listing of terms and conditions of the real estate plan agreement that may be accepted or modified by real estate buyer 21 during stage S101 and real estate seller 31 during stage S102. For this embodiment, webpage(s) 99c provides means for real estate buyer 21 and real estate seller 31 to confirm acceptance of the terms and conditions during stages S101 and S102.

For either embodiment of stage S103, real estate plan agent 23 may be a passive participant and/or an active participant. As a passive participant, real estate plan agent 23 may author a format for the real estate plan agreement and/or author the pre-listing of terms and conditions for stages S101 and S102. As such, web page(s) 99c may be presented on agent client terminal 25 whereby real estate plan agent 23 may ascertain the accepted terms and conditions. As an active participant, real estate plan agent 23 may engage in a chat room of web page(s) 99(c) designed to answer questions and address issues from real estate buyer 21 and/or real estate seller 31. Whether passive or active, real estate plan agent 23 has an account record 97 in database 94 to illustrate certification credentials for real estate buyer 21 and real estate seller 31.

Those having ordinary skill in the art will appreciate how to program various modules suitable to facilitate negotiations between real estate buyer 21 and real estate seller 31 for purposes of generating real estate plan agreement 98 (FIG. 5).

Upon completion of the negotiations, real estate plan agreement 98 is generated and stored within server 90 and a stage S104 of flowchart 100 encompasses server 90 automatically emailing notifications of the generation of real estate plan agreement 98 (FIG. 5) to all parties in need of such notification (e.g., real estate plan provider) and a transmission of real estate plan agreement 98 to all parties in need of a copy of real estate agreement 98 (e.g., real estate plan agent and closing administrator).

Those having ordinary skill in the art will appreciate how to program an email module suitable to email notifications and transmit documentation as required for stage S104.

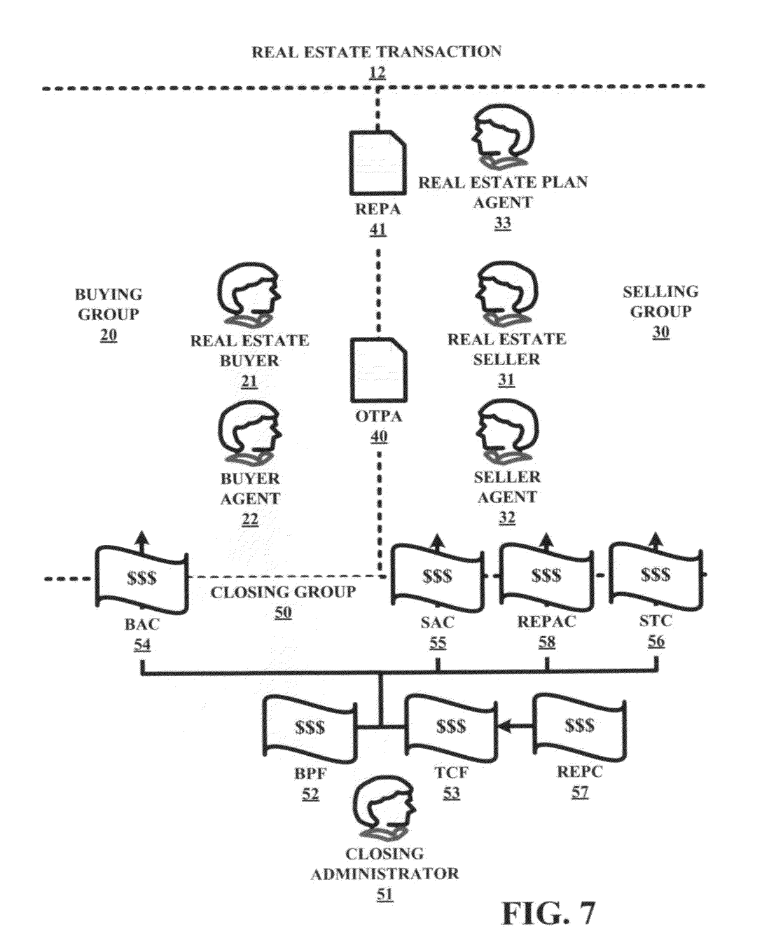

FIG. 7 illustrates a real estate transaction 12 involving the exercising of a seller real estate plan of the present invention. For this transaction, a real estate planning agent 33 is a member of selling group 30 and the inventive principles of exercising a buyer real estate plan as set forth herein in connection with FIGS. 3-6 are applicable to the exercise of a seller real estate plan with real estate seller 31 and real estate buyer 21 roles being reversed.

Although the present invention has been described with reference to exemplary aspects, features and implementations, the disclosed methods and systems are not limited to such exemplary aspects, features and/or implementations. Rather, as will be readily apparent to persons skilled in the art from the description provided herein, the disclosed systems and methods are susceptible to modifications, alterations and enhancements without departing from the spirit or scope of the present invention. Accordingly, the present invention expressly encompasses such modification, alterations and enhancements within the scope hereof.

1. A server-based method for executing a buyer real estate plan for addressing buyer transaction costs relative to a closing of a real estate transaction between a real estate buyer and a real estate seller, the server-based method comprising:
operating a real estate server to facilitate a negotiation between the real estate buyer and the real estate seller of a real estate plan commission fee payable to a real estate plan agent at the closing of the real estate transaction, wherein the real estate commission fee is representative of at least one duty of the real estate plan agent in executing the buyer real estate plan; and
operating the real estate server to generate a real estate plan agreement between the real estate buyer and the real estate seller, wherein the real estate plan agreement specifies the real estate plan commission fee.

2. The server-based method of claim 1, wherein the real estate commission fee is a percentage of a provisional purchase price of the real estate.

3. The server-based method of claim 1, wherein the real estate commission fee is a percentage of a negotiated purchase price of the real estate.

4. The server-based method of claim 1, wherein the real estate plan agreement is at least partially derived from a template of terms and conditions for the real estate plan agreement.

5. The server-based method of claim 4, further comprising:
operating the real estate server wherein the real estate plan agent creates and stores the template of terms and conditions for the real estate plan agreement on the real estate server prior to the negotiation between the real estate buyer and the real estate seller of the real estate plan commission fee.

6. The server-based method of claim 5, further comprising:
operating the real estate server wherein the real estate buyer and the real estate seller interact with the template of terms and conditions of the real estate plan agreement.

7. The server-based method of claim 1, further comprising:
operating the real estate server wherein the real estate plan agreement is at least partially derived from discussions between the real estate buyer and the real estate seller hosted by the real estate plan agent about terms and conditions of the real estate plan agreement.

8. The server-based method of claim 1, further comprising:
operating the real estate server to email a notification of an executed real estate plan agreement between the real estate buyer and the real estate server over a network to at least one client terminal.

9. The server-based method of claim 1, further comprising:
operating the real estate server to email a copy of an executed real estate plan agreement between the real estate buyer and the real estate server over a network to at least one client terminal.

10. The server-based method of claim 1, wherein the real estate agreement instructs a closing administrator to transact a payment of the real estate plan commission fee to the real estate plan agent at the closing of the real estate transaction.

11. A server-based system for executing a buyer real estate plan for addressing buyer transaction costs relative to a closing of a real estate transaction between a real estate buyer and a real estate seller, the server-based system comprising:
a processor; and
a real estate plan application including:
a negotiation module executable by the processor to facilitate a negotiation between the real estate buyer and the real estate seller of a real estate plan commission fee payable to a real estate plan agent at the closing of the real estate transaction, wherein the real estate commission fee is representative of at least one duty of the real estate plan agent in executing the buyer real estate plan; and
an agreement module executable by the processor to generate a real estate plan agreement between the real estate buyer and the real estate seller, wherein the real estate plan agreement specifies the real estate plan commission fee.

12. The server-based system of claim 11, wherein the real estate commission fee is a percentage of a provisional purchase price of the real estate.

13. The server-based system of claim 11, wherein the real estate commission fee is a percentage of a negotiated purchase price of the real estate.

14. The server-based system of claim 11, wherein the real estate plan agreement is at least partially derived from a template of terms and conditions for the real estate plan agreement.

15. The server-based system of claim 14, wherein the real estate plan application further includes:
a template module executable by the processor to facilitate a creation and storage by the real estate plan agent of the template of terms and conditions for the real estate plan agreement prior to the negotiation between the real estate buyer and the real estate seller of the real estate plan commission fee.

16. The server-based system of claim 15, wherein the real estate plan application further includes:
an interaction module executable by the processor to facilitate an interaction of the real estate buyer and the real estate seller with the template of terms and conditions of the real estate plan agreement.

17. The server-based system of claim 11, wherein the real estate plan application further includes:
a discussion module executable by the processor to facilitate discussions between the real estate buyer and the real estate seller as hosted by the real estate plan agent about terms and conditions of the real estate plan agreement.

18. The server-based system of claim 11, wherein the real estate plan application further includes:
an email module executable by the processor to email a notification of an executed real estate plan agreement between the real estate buyer and the real estate server over a network to at least one client terminal.

19. The server-based system of claim 11, wherein the real estate plan application further includes:
an email module executable by the processor to email a copy of an executed real estate plan agreement between the real estate buyer and the real estate server over a network to at least one client terminal.

20. The server-based system of claim 11, wherein the real estate agreement instructs a closing administrator to transact a payment of the real estate plan commission fee to the real estate plan agent at the closing of the real estate transaction.
